(19) United States
(12) Patent Application Publication
(10) Pub. No.: US 2009/0307409 A1
(43) Pub. Date: Dec. 10, 2009

(54) DEVICE MEMORY MANAGEMENT

(75) Inventors: Matthew Rogers, Sunnyvale, CA (US); Daniel R. Fletcher, Sunnyvale, CA (US); Matthew Byom, Campbell, CA (US); Timothy Patrick Hannon, Campbell, CA (US)

Correspondence Address: FISH & RICHARDSON P.C., PO BOX 1022, MINNEAPOLIS, MN, 55440-1022, US

(73) Assignee: Apple Inc., Cupertino, CA (US)

(21) Appl. No.: 12/134,998

(22) Filed: Jun. 6, 2008

(51) Int. Cl. G06F 12/00

(52) U.S. Cl. 711/100; 711/E12.001

(57) ABSTRACT

Methods, systems, devices, and apparatus, including computer program products, for memory management. Usage data associated with one or more files is identified and stored in a volatile memory of a device. The usage data is maintained in the volatile memory is maintained during and after a reset of the device. After the reset, the usage data can be written to a non-volatile memory.

### BACKGROUND

This specification is related generally to management of memory systems.

Portable devices, such as handheld computers, mobile phones, digital cameras, portable music players, and so on, can include both volatile and non-volatile memory. Volatile memory can be expensive, and thus the capacity of volatile memory in devices is minimized as much as possible. Non-volatile memory (e.g., hard disk drive, flash and other solid-state memory), on the other hand, have different limitations, such as speed, reliability, and overhead restraints, for example. Thus, memory management systems in portable devices need to accommodate both the relatively small capacities of volatile memory in the devices and the limitations of non-volatile memory.

### SUMMARY

In general, one aspect of the subject matter described in this specification can be embodied in systems that include non-volatile memory storing one or more files, volatile memory, and one or more processors configured to persistently store usage data associated with the one or more files in the volatile memory during and after a reset of the system. Other embodiments of this aspect include corresponding methods, apparatus, devices, computer program products, and computer readable media.

In general, another aspect of the subject matter described in this specification can be embodied in devices that include a non-volatile memory storing one or more files, and a host controller including a volatile memory and one or more processors, where the one or more processors are configured to identify usage data associated with the one or more files and to store the usage data in the volatile memory, and where the usage data that is stored in the volatile memory persists in the volatile memory during and after a reset of the host controller. Other embodiments of this aspect include corresponding methods, systems, apparatus, computer program products, and computer readable media.

In general, another aspect of the subject matter described in this specification can be embodied in methods that include identifying usage data associated with one or more files, storing the usage data in a volatile memory of a host controller, resetting the memory system, and maintaining the usage data in the volatile memory during and after the resetting. Other embodiments of this aspect include corresponding systems, apparatus, devices, computer program products, and computer readable media.

In general, another aspect of the subject matter described in this specification can be embodied in methods that include storing usage data in a volatile memory of a device while the device is in a first mode of operation, where the usage data is maintained in the volatile memory during a reset of the device, resetting the device, and, after the resetting, writing the usage data from the volatile memory into a non-volatile memory of the device while the device is in a second mode of operation. Other embodiments of this aspect include corresponding systems, apparatus, devices, computer program products, and computer readable media.

In general, another aspect of the subject matter described in this specification can be embodied in devices that a non-volatile memory, a volatile memory, and one or more processors, where a first set of instructions is stored in the volatile memory during a first mode of operation for the device, the first set of instructions configured for execution by the one or more processors and including instructions to store usage data in the volatile memory, and where a second set of instructions is stored in the volatile memory during a second mode of operation for the device after a reset of the device, the second set of instructions configured for execution by the one or more processors and including instructions to write the usage data from the volatile memory to the non-volatile memory. Other embodiments of this aspect include corresponding methods, systems, apparatus, computer program products, and computer readable media.

Particular embodiments of the subject matter described in this specification can be implemented to realize one or more of the following advantages. Frequently updated data can be stored without performing excessive read/write cycles on non-volatile memory and with a lower risk of loss due to crashes or resets. Frequently updated data can be recovered from volatile memory after a crash or reset. Power consumption and system responsiveness can be improved by reducing the read/write cycles to non-volatile memory.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating the system architecture of an example device.

FIG. 2 illustrates example contents in a volatile memory.

FIG. 3 is a flow diagram illustrating an example process for storing data in volatile memory.

FIGS. 4A-4B illustrate example contents in a volatile memory during different modes of operation.

FIG. 5 is a flow diagram illustrating an example process for multi-mode operation of a device.

Like reference numbers and designations in the various drawings indicate like elements.

### DETAILED DESCRIPTION

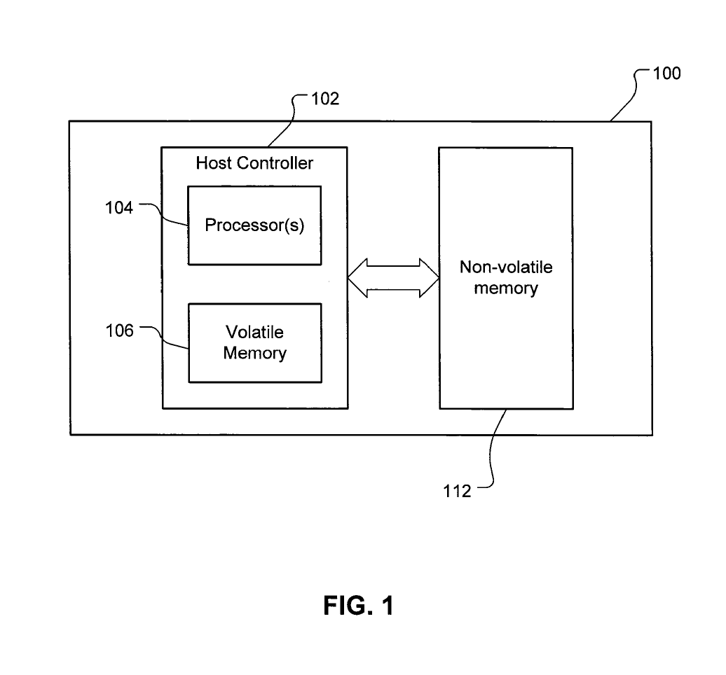

FIG. 1 is a block diagram illustrating the system architecture of an example device 100. In some implementations, the device 100 is a portable device, such as a media player device, a personal digital assistant, a mobile phone, portable computers, digital cameras, and so on, for example.

The device 100 includes a host controller (or a so-called “system-on-a-chip”) 102 and non-volatile memory 112. The device 100 can optionally include additional memory external to the host controller 102 and the non-volatile memory 1 12. The host controller includes one or more processors 104 and volatile memory 106. In some implementations, volatile memory 106 is static random-access memory (SRAM). The host controller performs various processing operations and input/output operations. For example, the host controller can receive and process user inputs, generate outputs, perform media (e.g., audio, video, graphics) decoding and processing operations, other processing operations, and so on. The host controller 102 can read data from and write data to volatile memory 106. The host controller 102 can also issue read or write operations to the non-volatile memory 112 through an interface (not shown).

In some implementations, the non-volatile memory 112 is NAND flash memory. In some other implementations, the non-volatile memory 112 is another type of non-volatile memory, such as NOR flash memory, other types of solid state memory, or a hard disk drive, for example.

The host controller 102 can also collect usage data with respect to one or more data files (e.g., media files) stored on the device 100. Usage data can include, for example, play counts and skip counts for media (e.g., audio, video, multimedia, etc.) files, data regarding shuffling of the playback order of media files, various statistics, crash or error logs, and so on. Usage data can be generated whenever particular events (e.g., a playback of a media file, a skip of a media file, etc.) occur. More generally, usage data can include data that are generated as users of the device interact with data files and the device and as particular operations or functions are performed on the device; thus, usage data tends to be generated and updated relatively frequently during device use. The host controller 102 can store the usage data in the volatile memory 106.

The device 100 also includes a power supply (not shown). The power supply can receive electrical power from power source (e.g., a battery, a wall power outlet) and supply the power to the various components of the device 100. The device 100 can also include one or more other components that have been omitted from FIG. 1 for clarity.

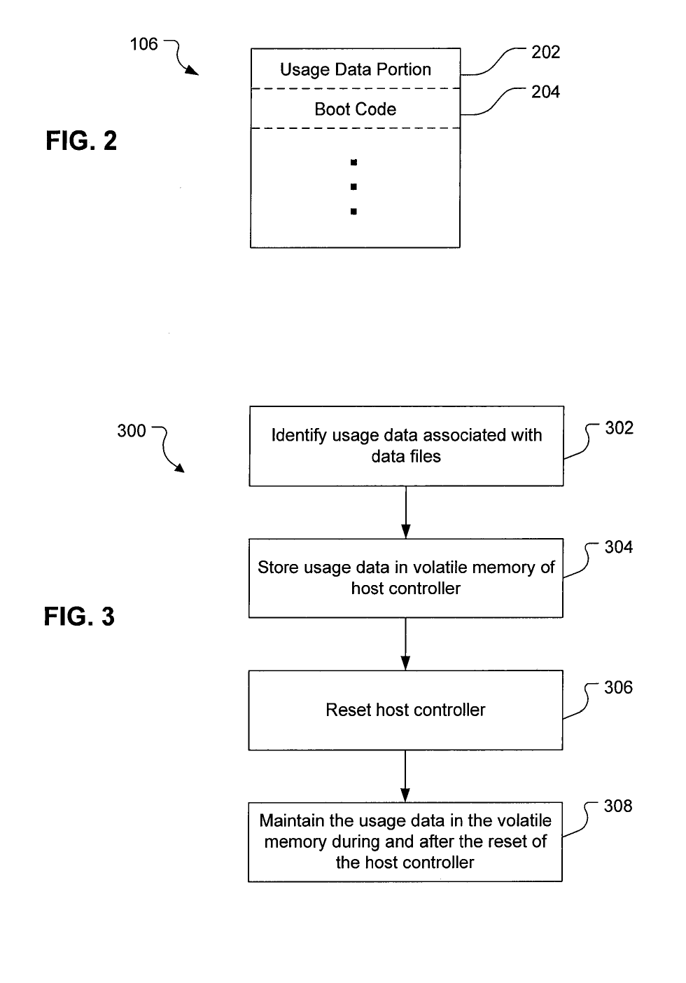

FIG. 2 illustrates example contents in a volatile memory. Volatile memory 106 can include a reserved portion 202 for storing usage data. In some implementations, the size of the reserved portion 202 can be dynamically allocated by host controller 102. Volatile memory 106 can also store, for example, boot code 204 (which can be executed by the host controller 102 to boot up the device), and other data, applications, or drivers (e.g., a media playback application, a non-volatile memory read-only driver or read/write driver). In some implementations, boot code 204 can originally be stored in non-volatile memory 112 and loaded into volatile memory 106 for execution.

In some implementations, a data pointer that points to the starting address of the reserved portion 202 can be stored in the host controller 102 (e.g., in one or more registers). An offset or length can also be used with the data pointer to determine the boundaries of the reserved portion 202. The data pointer and offset/length allows the host controller 102 to dynamically adjust the size of the reserved portion 202 based on the memory needs of the device 100 or any other factor. For example, the host controller 102 can determine the amount of usage data (e.g., determined from historical data or predicted) and dynamically update a starting address and offset/length in one or more registers in the host controller 102. The host controller 102 can access the usage data stored in the reserved location 202 using the registers.

The host controller 102 can be reset upon the occurrence of particular reset events. For example, the host controller 102 can be reset when device 100 docks with another device (e.g., a media player device docking with a desktop or notebook computer), when the device 100 crashes, and so on. In some implementations, reset events include, for example, docking or tethering to a host computer (e.g., a desktop or notebook computer) and synchronizing data with the host computer, a crash, a software exception, a soft reset, and a firmware update process. In some implementations, when the host controller 102 is reset, the processor 104 is reset but the volatile memory 106 is not flushed of its content (and any power that is being supplied to the volatile memory 106 is not interrupted). Thus, the contents of the volatile memory 106, including the usage data, can be maintained in the volatile memory 106 during and after a reset of the host controller 102.

FIG. 3 is a flow diagram illustrating an example process 300 for storing data in volatile memory. For convenience, the process 300 will be described with reference to a device (e.g., device 100) that performs the process.

Usage data associated with one or more data files are identified (302). The host controller 102, for example, identifies and generates data (e.g., usage data) associated with data files as host controller 102 performs operations on the data files (e.g., media files). The usage data can be identified and generated continuously or in bursts.

The usage data is stored in the volatile memory of the host controller (304). For example, the host controller 102 can store the identified and generated usage data in volatile memory 106. In some implementations, the usage data is stored in a reserved usage data portion 202 of the volatile memory 106.

The host controller is reset (306). For example, the device 100, including the host controller 102, can be reset upon an occurrence of a reset event. For example, the host controller 102 can be reset when the device 100 docks with a computer for syncing, after the device 100 suffers a crash or fatal error, and so on. During the reset of the host controller 102, the processor 104 is reset, all the while power (if available) is still supplied to the volatile memory 106, and the contents of the volatile memory 106 are not flushed.

The usage data is maintained in the volatile memory during and after the resetting of the host controller (308). As described above, power is supplied to the volatile memory 106 during the reset, and the contents of the volatile memory 106 are not flushed (where flushing of the volatile memory can be achieved, for example, by writing zeros or other known values into memory 106). Thus, the usage data that is in the volatile memory 106 at the time of the reset is maintained during and after the reset, making the usage data available to the host controller 102 after the reset operation; the usage data persists in the volatile memory 106 during and after the reset.

In some implementations, the host controller 102 can write (e.g., copy) the usage data stored in the volatile memory 106 to the non-volatile memory 112 upon occurrence of a predetermined event or at a predetermined interval. For example, usage data can be written from the volatile memory 106 to the non-volatile memory 112 daily, weekly, or bi-weekly. As another example, usage data can be written from the volatile memory 106 to the non-volatile memory 112 after a reset of the device 100, including the host controller 102, due to the occurrence of a reset event; or when the reserved portion 202 of the volatile memory 106 is filled to capacity.

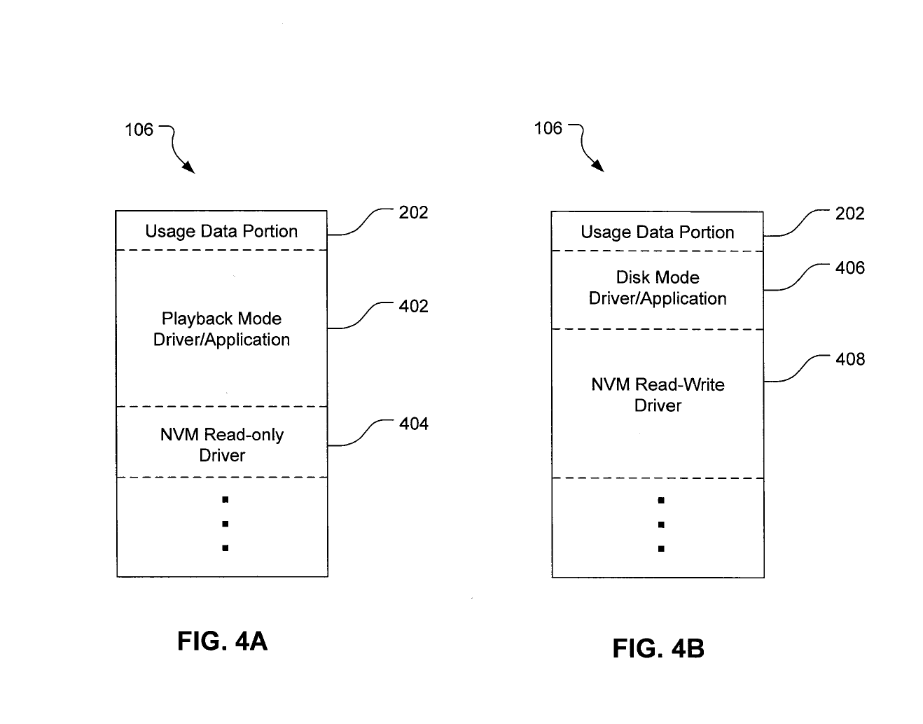

In some implementations, the device 100 operates in different modes depending on the particular situation, and load drivers, data, and applications specific to the operating mode in order to conserve volatile memory. For example, the device 100 can operate in a playback mode or a disk mode. In playback mode, a playback mode driver/data/application 402 and a non-volatile memory (NVM) read-only driver 404 can be loaded into the volatile memory 106, as shown in FIG. 4A. The playback mode driver/data/application 402 can decode and play media files (e.g., audio files) and store usage data into the usage data portion 202. The NVM read-only driver can read data from the non-volatile memory 112.

In response to a reset event (e.g., crash, docking or syncing with a computer, etc.) that has occurred on device 100 or at a predetermined interval, the device 100 can be reset and then enter a disk mode. In disk mode, different drivers and applications can be loaded into volatile memory 106 than in playback mode. For example, in disk mode, a disk mode driver/application 406 and a NVM read-write driver 408 can be loaded into the volatile memory 106, as shown in FIG. 4B. The disk mode driver 406, operating in conjunction with the NVM read-write driver 408, can write usage data from the usage data portion 202 into the non-volatile memory 1 12.

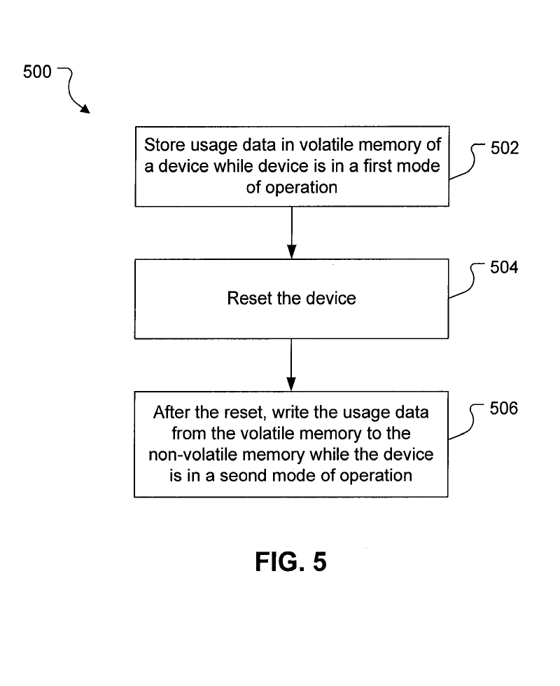

FIG. 5 is a flow diagram illustrating an example process 500 for multi-mode operation of a device. For convenience, the process 500 will be described with reference to a device (e.g., device 100) that performs the process. In this specific example, the device 100 is a media player that has a playback mode and a disk mode for syncing with a host computer to download audio or video files.

Usage data is stored in a volatile memory of a device while the device is in a first mode of operation (502). For example, device 100 can be operating in a playback mode (e.g., the user is listening to music). While the device 100 is in playback mode, playback mode driver/application 402 can store usage data in the usage data portion 202 of volatile memory 106. As described above, the usage data can be maintained (i.e., the usage data persists) in the volatile memory during and after a reset of the device 100.

The device is reset (504). The device 100, including the host controller 102, resets when a reset event occurs. As described above, a reset event can include, for example, a crash of the device 100 or a docking/tethering of the device 100 to a host computer (e.g., the device is tethered to the host computer and syncing with a library on the host computer). During the reset, the usage data is maintained in volatile memory 106 as long as power is still being supplied to the volatile memory 106.

The usage data is written from the volatile memory to a non-volatile memory while the device is in a second mode of operation (506). After the reset, the device 100 can enter into a disk mode of operation. In disk mode, the disk mode driver 406, in conjunction with the NVM read-write driver 408, can copy the usage data from the usage data portion 202 of the volatile memory 106 to the non-volatile memory 112.

In some implementations, the usage data in the volatile memory 106 are validated by the disk mode driver 406 or some other driver or application before the usage data is written into the non-volatile memory 112. For example, signatures or hashes of the usage data can be validated before writing the usage data to the non-volatile memory.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A system comprising:
non-volatile memory storing one or more files;
volatile memory; and
one or more processors configured to persistently store usage data associated with the one or more files in the volatile memory during and after a reset of the system.

2. The system of claim 1, wherein the one or more processors are configured to persistently store the usage data in a reserved portion of the volatile memory.

3. The system of claim 2, wherein the system further comprises one or more registers, the registers including pointer data that demarcates the reserved portion.

4. The system of claim 3, wherein the one or more processors are further configured to dynamically adjust a size of the reserved portion by modifying the pointer data.

5. The system of claim 1, wherein the one or more processors are configured to write the usage data from the volatile memory to the non-volatile memory in response to the reset of the system.

6. The system of claim 1, wherein the reset of the system is in response to an occurrence of a reset event.

7. The system of claim 1, wherein the one or more processors are configured to write the usage data from the volatile memory to the non-volatile memory at a predetermined time interval.

8. The system of claim 1, wherein the one or more files comprise one or more media files.

9. A device, comprising:
a non-volatile memory storing one or more files;
a host controller comprising:
a volatile memory; and
one or more processors;
wherein the one or more processors are configured to identify usage data associated with the one or more files and to store the usage data in the volatile memory; and
wherein the usage data that is stored in the volatile memory persists in the volatile memory during and after a reset of the host controller.

10. The device of claim 9, wherein the reset of the host controller comprises a reset of the one or more processors.

11. The device of claim 9, wherein the one or more processors are configured to write the usage data from the volatile memory to the non-volatile memory in response to the reset of the host controller.

12. The device of claim 9, wherein the one or more processors are configured to write the usage data from the volatile memory to the non-volatile memory at a predetermined time interval.

13. The device of claim 9, wherein the files comprise one or more media files.

14. A method comprising:
identifying usage data associated with one or more files;
storing the usage data in a volatile memory of a host controller;
resetting the memory system; and
maintaining the usage data in the volatile memory during and after the resetting.

15. The method of claim 14, wherein the resetting comprises resetting the host controller.

16. The method of claim 14, wherein maintaining the usage data in the volatile memory during and after the resetting comprises maintaining power to the volatile memory during and after the resetting.

17. The method of claim 14, wherein storing the usage data comprises storing the usage data in a reserved portion of the volatile memory.

18. The method of claim 17, further comprising dynamically adjusting a size of the reserved portion by modifying pointer data that demarcates the reserved portion.

19. The method of claim 14, further comprising writing the usage data from the volatile memory to a non-volatile memory in response to the resetting.

20. The method of claim 14, further comprising writing the usage data from the volatile memory to a non-volatile memory at a predetermined time interval.

21. The method of claim 14, wherein the data files comprise one or more media files.

22. A method, comprising:
storing usage data in a volatile memory of a device while the device is in a first mode of operation, wherein the usage data is maintained in the volatile memory during a reset of the device;
resetting the device; and
after the resetting, writing the usage data from the volatile memory into a non-volatile memory of the device while the device is in a second mode of operation.

23. The method of claim 22, wherein a first set of drivers are stored in the volatile memory during the first mode of operation, and a second set of drivers are stored in the volatile memory during the second mode of operation.

24. The method of claim 22, further comprising validating the usage data before the writing.

25. The method of claim 22, wherein the resetting is performed in response to an occurrence of a reset event on the device.

26. A device, comprising:
a non-volatile memory;
a volatile memory; and
one or more processors;
wherein a first set of instructions is stored in the volatile memory during a first mode of operation for the device, the first set of instructions configured for execution by the one or more processors and comprising instructions to store usage data in the volatile memory; and
wherein a second set of instructions is stored in the volatile memory during a second mode of operation for the device after a reset of the device, the second set of instructions configured for execution by the one or more processors and comprising instructions to write the usage data from the volatile memory to the non-volatile memory.
